(19) United States
(12) Patent Application Publication
(10) Pub. No.: US 2008/0245863 A1
(43) Pub. Date: Oct. 9, 2008

(54) SHOPPER AND ITEM AWARE STOREFRONT THAT PROVIDES AN ENHANCED SHOPPING EXPERIENCE THROUGH AUTOMATED STOREFRONT INTERACTIONS

(76) Inventor: BRIAN K. BUCHHEIT, DAVIE, FL (US)

Correspondence Address: PATENTS ON DEMAND, P.A., 4581 WESTON ROAD, SUITE 345, WESTON, FL, 33331, US

(21) Appl. No.: 11/696,021

(22) Filed: Apr. 3, 2007

(51) Int. Cl. G06F 17/00

(52) U.S. Cl. 235/383

(57) ABSTRACT

The present invention discloses a storefront shopping technique that enhances shopping by presenting information to a shopper about proximate for-sale items. Both the shopper and the for-sale items can be associated with location beacons. The presented information can be specific to the shopper, which requires that an identity of the shopper be determined. In the technique, shopper specific information can be obtained from a data store to determine at least one of the for-sale items likely to be of interest to the shopper. A shopper proximity to the for-sale items can be detected based upon a location of the item location beacon associated with the determined for-sale item and based upon a location of the shopper location beacon. When the shopper is proximate to the for-sale item, information can automatically be presented to the shopper via an electronic device about the determined for-sale item.

### FIELD OF THE INVENTION

The present invention relates to the field of commerce, more particularly, to a shopper and item aware storefront that provides an enhanced shopping experience through automated storefront interactions.

### DESCRIPTION OF THE RELATED ART

Traditional storefront shopping and online shopping are very similar in some respects but are quite different in others. Both modes of shopping are advantageous in many ways. One of the major advantages of online shopping is the presence of specific information about items that is available to the shopper to review before purchasing. This information can be other shoppers' reviews about the item or a list of recommended items that have been purchased by other shoppers. For example, a customer purchasing a compact disc (CD) of music by Beethoven may read a review of the CD to ascertain if the CD would be to their liking. Another common feature of online shopping is the ability to create comparison based lists of two or more items of interest. For instance, a shopper can compare two or more potential laptops in a side by side comparison table showing the list of available features for each laptop.

Many online shopping websites take advantage of customized advertising in the form of email based coupons and specials which are generally not available to the public. For example, after purchasing a stereo system, a purchaser may receive special discounts on stereo cables and components. In another example, an online website can track its valued customers and provide special coupons on items in their inventory to entice their customers in an effort to target certain segments of their sales.

Storefront purchasing has several advantages compared to its online counterpart. One of the major advantages of storefront purchasing is the ability to physically handle and inspect items before purchasing the items. For example, shoe-wear can be very difficult to purchase online, due to the inability to establish the correct size which can vary between manufacturers. Storefront purchases for shoes can remove possible errors in purchasing by allowing the purchaser to find a proper fitting item through some method of trial and error.

Immediate receipt of an item is another advantage of storefront purchasing which online purchasing cannot duplicate. In some instances purchasers require immediate use of items purchased such as replacing non-functioning items. For example, replacing a non-functioning automotive brake light is an item that would benefit from an immediate substitution. Some packaged electronic items can be defective and the purchaser cannot establish this until unpacking and installing the item. In this case a return of the item in is necessary. Return of the defective item from a storefront is significantly easier than a defective item which is purchased online. For example, a defective computer monitor that is purchased from a storefront site can be easily returned by physically returning the item to the storefront. Whereas a defective computer monitor purchased online would require shipping the monitor back to the online store. This shipping requirement results in a significant loss of time and money on the part of the purchaser. While online shopping is popular, storefront shopping is still a preferred way to purchase most items. It would be advantageous to enhance storefront shopping experiences to provide some of the advantages historically only available through online shopping channels of commerce.

### SUMMARY OF THE INVENTION

The present invention discloses a technique of providing additional information to shoppers about storefront items. This information can include customer reviews, listings of competing products, and other information. Further, storefront shoppers can be automatically notified of proximate items believed to be of interest to them and/or can be guided to a location of a desired object. This is analogous to showing items/information of interest based upon a set of items appearing within an online shopping Web site. Additionally, using shopper history information, targeted advertisements can be delivered to shoppers while in the storefront. Further still, shopper specific rebates can be automatically filled out for the shopper at a time of purchase and can be electronically submitted to a rebate destination. All of these advantages require an enhanced storefront awareness of shopper locations within a store relative to items contained in the store. Once this awareness has been added, storefronts can provide new interactive options to enhance an overall shopper experience.

The present invention can be implemented in accordance with numerous aspects consistent with material presented herein. For example, one aspect of the present invention includes a method for storefront shopping that includes a step of associating at least one item location beacon with at least one for-sale item in a store. Different for-sale items can be associated with different item location beacons. A shopper location beacon can be associated with a movable object proximate to a shopper present in the store. An identity of the shopper can be determined. Shopper specific information can be obtained from a data store to determine at least one of the for-sale items likely to be of interest to the shopper. A shopper proximity to the for-sale items can be detected based upon a location of the item location beacon associated with the determined for-sale item and based upon a location of the shopper location beacon. When the shopper is proximate to the for-sale item, information can automatically be presented to the shopper via an electronic device about the determined for-sale item.

Another aspect of the present invention includes an enhanced shopping method, where a computing system automatically determines a proximity between a storefront shopper and a for-sale item. In the method, a shopper data store containing shopper specific information can be accessed. A shopper targeted event relating to both the shopper and the for-sale item can be automatically initiated based upon a proximity between the two. The initiation of the event can be based at least in part upon decisions determined from the shopper specific information. A programmatic action can be executed responsive to the initiated event. Enhanced shopping information resulting from the programmatic action and relating to a unique relationship between the shopper and the for-sale item can be presented upon a shopper accessible interface.

Still another aspect of the present invention includes an enhanced shopping system that includes a storefront, a shopper data store, an item data store, and a shopper interface device. The storefront can be a building within which shoppers purchase for-sale items. The shopper data store can maintain shopper preferences relevant to the storefront. The item data store can maintain information specific to the for-sale items. The shopper interface device can interactively present information to a shopper specific to the shopper and proximately located for-sale items. The presented information can be customized based upon a relationship between the shopper and the for-sale items as determined from the shopper preferences and the information specific to the for-sale items.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 illustrates a few scenarios for a shopper and item aware storefront system in accordance with embodiments of the inventive arrangements disclosed herein.

FIG. 2 is a schematic diagram illustrating a system in which shoppers and items have location awareness capabilities that are used to enhance storefront shopping in accordance with the embodiments of the inventive arrangements disclosed herein.

FIG. 3 is a schematic diagram illustrating graphical user interface (GUI) associated with a shopper interface device in accordance with an embodiment of the inventive arrangements disclosed herein.

### DETAILED DESCRIPTION OF THE INVENTION

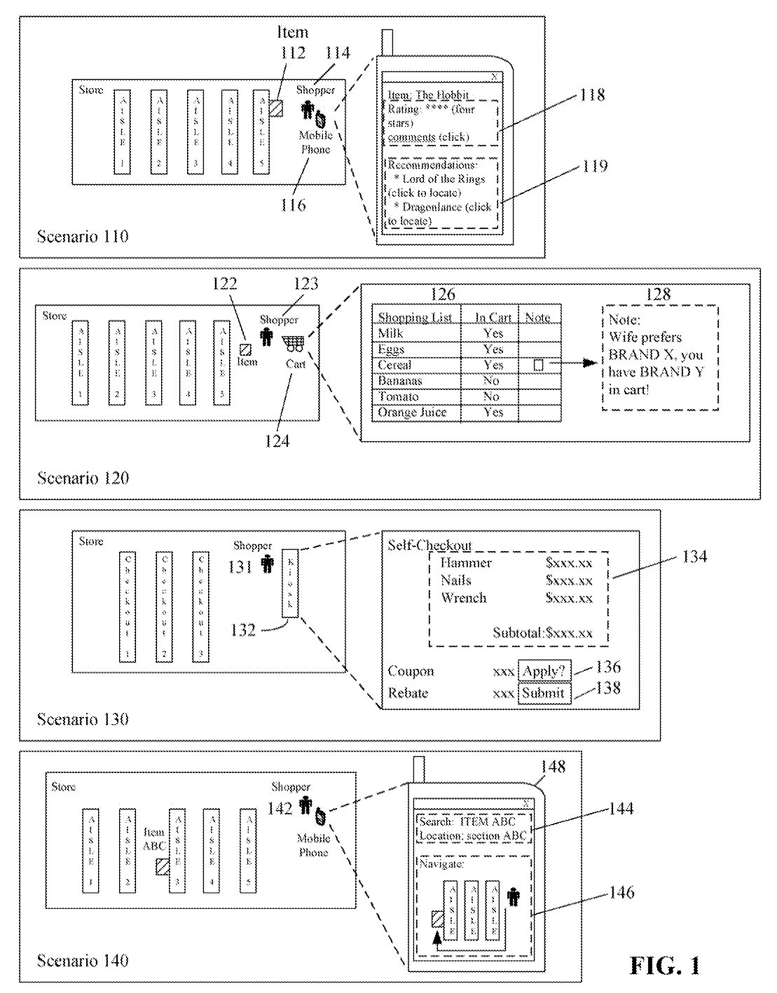

FIG. 1 illustrates scenarios 110-140 for a shopper and item aware storefront system in accordance with embodiments of the inventive arrangements disclosed herein. In each scenario 110-140, a shopper is provided information related to nearby items via a communication device. The provided information can be based upon shopper preferences and historical purchasing information.

Scenario 110 illustrates a shopper 114 in a bookstore, who is carrying a mobile phone 116. Either the shopper 114 or the mobile phone 116 can include a location beacon which is used to determine the shopper's 116 in-store position. Location beacons can also be placed on various for-sale items, such as item 112, which in scenario 110 is a book. An in-store computing system can determine that book 112 is likely to be of interest to shopper 114 based upon previously established preferences, purchase history, and other factors. As the shopper 114 moves about in the store, the mobile phone 116 can present information related to different nearby for-sale items.

For example, the mobile phone 116 can present a shopper rating and shopper comments 118 for item 112. Shopper recommendations 119 can also be presented to help the shopper 114 identify other items similar in nature to item 112 or enjoyed by past purchasers of item 112.

Using a specific instance of scenario 110, shopper 114 can have a past purchase history of fantasy books. When the shopper 114 approaches item 112, which is a book “The Hobbit”, a notification concerning the book along with other nearby books can be presented upon the phone 116. The shopper 114 can select the item 112 using an interface of the phone 116, which presents user rating information 118 and recommendations 119 related to “The Hobbit”.

Scenario 120 illustrates a shopper 123 in a grocery store, who is using a location-aware shopping cart 124 having an embedded computing display. The shopping cart 124 can convey a shopper 123 specific shopping list 126. For-sale items can be tagged with location beacons, such as RFID tags, which the cart 124 can read. When for-sale items are placed in the cart 124 that are contained in the shopping list 126, the list can be automatically updated. Further, the shopper 123 can be informed by the cart 124 when the shopper 123 is near an item 122 on the list 126, which has yet to be acquired. Additionally, notices 128 can be presented when an item added to the cart 124 is either different from an item on list 126 or contradicts past purchases. For instance, a notice 128 can inform shopper 123 that he placed BRAND Y in the cart 124 even though his wife prefers BRAND X.

Scenario 130 illustrates a shopper 131 using a self-service kiosk 132 to purchase items from a home improvement store. The self checkout kiosk 132 can uniquely identify the shopper and for-sale items, which the shopper is purchasing through the kiosk 132. The kiosk 132 can also be linked to a data store having shopper 131 specific information, which is used during shopper-kiosk interactions. For example, the kiosk 132 can compare check-out items against a shopping list (similar to scenario 120). Further, shopper-specific coupons 136 relating to check-out items 134 can be automatically applied to a kiosk transaction. Further, the kiosk 132 can facilitate rebate 138 submissions relating to the check-out items 134.

Scenario 140 illustrates a shopper 142 using a mobile phone 148, which navigates the shopper to in-store items. The items can be specified in interface section 144. Interface section 146 can then present a map, which guides the shopper 142 to the specified item. In one embodiment, the map of section 146 can be dynamically updated as the shopper 142 moves about the store.

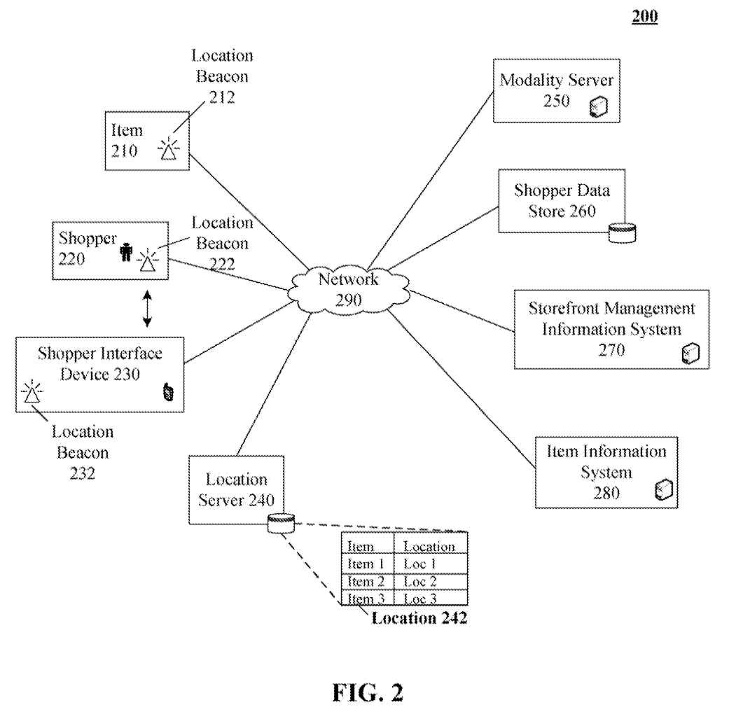

FIG. 2 is a schematic diagram illustrating a system 200 in which shoppers 220 and items 210 have location awareness capabilities that are used to enhance storefront shopping in accordance with the embodiments of the inventive arrangements disclosed herein. System 200 can be used to perform actions illustrated in scenarios 110-140.

The location awareness capabilities of system 200 can result from a set of location beacons 212, 222, 232 that are attached to items 210, shoppers 220, and/or shopping devices 230. The location beacons 212, 222, 232 can determine relative positions using direct peer-to-peer communications. Location awareness can also require a use of location server 240, which manages positions of the location beacons 212, 222, 232 in system 200.

In-store interactions can be based upon shopper specific data contained in shopper data store 260, item specific information contained in item information system 280, and storefront specific rules contained in storefront management information system 270. In one embodiment, system 200 can include a modality server 250 which can handle interactions using different input/output modalities, such as a voice modality, a text modality, and a GUI modality. The modality server 250 can permit devices (e.g., shopper carried phones and store provided interface devices 230) of differing capabilities to make advantageous use of device specific capabilities. A network 290 can communicatively link the various components of system 200 to each other.

As used herein, the location beacons 212, 222, 232 can be any computing component capable of determining a relative or absolute position. Location beacons 212, 222, 232 can include global positioning system (GPS), Long Range Radio Navigation (Loran), LOJAC, or other location detection components. Location beacons 212, 222, 232 can also be implemented as radio frequency identification (RFID) tags, which actively, semi-actively, or passively communicate with one or more RFID scanners when proximately located. A series of RFID scanners can determine a location of a beacon 212, 222, 232 based upon whether the beacons 212, 222, 232 are within range of which scanners. Similarly, short range transeivers (e.g., BLUETOOTH, WIFI (any of the 802.11 based family of protocols) mobile telephony transceiver, and the like) can be used as location beacons 212, 222, 232 since a location of the transceiver can be determined based upon which broadcasting hub/communicating device is within transmission range of the transceiver. Transmission characteristics, such as signal strength, and triangulation techniques can be used to increase an accuracy of location determinations in situations in which transceivers are used as location beacons 212, 222, 232.

The location server 240 can facilitate location determinations. Location server 240 can execute algorithms (triangulation algorithms for example), which determine a location of one or more beacons 212, 222, 232. A location table 242 can be continuously updated that includes locations of items 210, shoppers 220, and/or devices 230. Additionally, the location server 240 can trigger events, such as a notification event, based upon a proximity of the various location beacons 212, 222, 232 to one another.

The item 210 can be any for-sale item contained in a store. Item 210 can include grocery store items, books, tools, pictures, furniture, and any other consumer good. Additionally, information specific to an item 210 can be contained within item information system 280 which can be accessible via network 290. System 280 can be an information system provided by an item manufacturer, a retail store, an independent product evaluation group, a trusted (or untrusted) third party, and other such systems. Information from system 280 can be presented directly to an in-store shopper 220 via interface device 230.

Item 210 does not necessarily need to have a location beacon 212 directly associated with it. In one embodiment, a location beacon 212 can be associated with a group of items 210 having a particular category. A category-specific computing device (not shown) equipped with a beacon 212 can be used to provide information for all items 210 of that category. The category specific computing device can be communicatively linked with a storefront management information system 270 which includes an updated inventory of in-store items. Thus inventory can be indexed by category which permits the category specific computing device to maintain a listing of current items. Periodic manual inventories can be used to correct mistakes in an automated inventory process.

To illustrate, a bookstore can organize books by categories. Each category (or book shelf) can include a category specific computing device which is able to communicate information about books in that category to shoppers 220 and/or shopper interface devices 230. As shoppers purchase books and as new books are made available for-sale by the bookstore, inventory changes are made to the storefront management information system 270 which can be communicated to the category specific computing device.

The shopper 220 can be a physical person who shops in a storefront location. Information specific to the shopper 220 can be stored in shopper data store 260. This information can include shopper personal information (e.g., name, address, phone, birth date), past purchase history, shopper preferences (i.e., either entered by shopper or inferred from data mining past transactions), and the like. In one embodiment, the shopper data store can include a memory space that a shopper 220 or an agent of the shopper 220 is able to access from the Web, which is made available to the shopper 220 when he/she is in the storefront. For example, a shopper 220 or a shopper's spouse can enter a shopping list in a suitable Web site linked to network 290 which is used for storefront interactions, as shown in scenario 120.

The shopper interface device 230 can be any device capable of interacting with the shopper 220. For example, device 230 can be a mobile telephone, a smart shopping cart, a smart shopping basket, a wearable computing device, a media player, a portable entertainment console, a kiosk, an automated check-out counter, a cashier's checkout system, and the like. The device 230 can communicate through different modalities, such as using speech input/output, using a graphical user interface (GUI) input/output, using tactile controls to accept shopper 220 input, and the like.

In one embodiment, a modality server 250 can be used to handle the different interactive modalities of devices 230. In one embodiment, modality server 250 can have device specific interface constraints. For example, different shoppers 220 carry different types of mobile phones, which can serve as devices 230. Depending on screen size, resolution, speech interaction capabilities, etc., of the mobile telephone, different presentation adjustments will be required by system 200,\ which modality server 250 can handle. In another embodiment, interactive modalities can be implemented independent of other computing components of system 200. For example, a composite services model can be used to implement system 200 applications in a modality independent manner.

A special situation can occur in system 200 where determinations based on location beacons 212, 222, 232 are unnecessary. That situation is one in which a shopper 220 and/or an item 210 position is inherently near device 230. For example, when device 230 is a kiosk, a location of a shopper 220 is inherently known, while that shopper is interacting with the kiosk. Similarly, the kiosk can include a bar-code scanner, which identifies items 210, at which point the item 210 location is known. The kiosk can also include a credit card reader which can be used to scan a credit card that identifies a shopper 220. Thus, an interactive kiosk (device 230) can provide “location-aware” enhancements described herein (e.g., item ratings, reviews, recommendations, etc.) without requiring a use of beacons 212, 222, 232 or location server 240, as shown by scenario 130.

Network 290 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 290 can include local components and data pathways necessary for communications to be exchanged among computing device components and between integrated device components and peripheral devices. The network 290 can also include network equipment, such as routers, data lines, hubs, and intermediary servers which together form a packet-based network, such as the Internet or an intranet. The network 290 can further include circuit-based communication components and mobile communication components, such as telephony switches, modems, cellular communication towers, and the like. The network 290 can include line based and/or wireless communication pathways.

The various computing devices of system 200 (i.e., items 230-280 as well as beacons 212, 222, 232) can each have associated data stores. Each data store can be a physical or virtual storage space configured to store digital information. Each data store can be physically implemented within any type of hardware including, but not limited to, a magnetic disk, an optical disk, a semiconductor memory, a digitally encoded plastic memory, a holographic memory, or any other recording medium. The data stores can be a stand-alone storage unit as well as a storage unit formed from a plurality of physical devices. Additionally, information can be stored within the data stores in a variety of manners. For example, information can be stored within a database structure or can be stored within one or more files of a file storage system, where each file may or may not be indexed for information searching purposes. Further, the data stores can utilize one or more encryption mechanisms to protect stored information from unauthorized access.

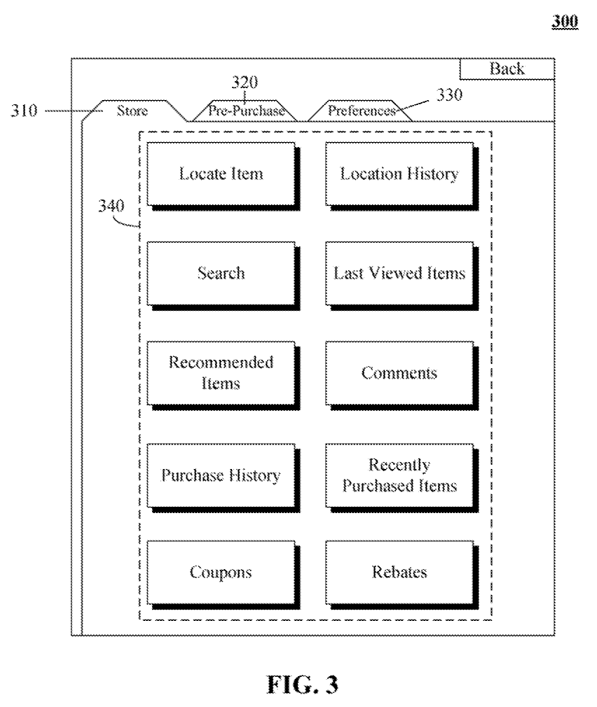

FIG. 3 is a schematic diagram illustrating graphical user interface (GUI) 300 associated with a shopper interface device in accordance with an embodiment of the inventive arrangements disclosed herein. The GUI 300 can be an interface of device 230 or can be any interface illustrated in scenarios 110-140.

The interface 300 can be capable of presenting interactive information to a shopper, who is located in a storefront. The information can include item specific information. Further, different information can be dynamically presented within the interface 300 depending upon positional relationships between a shopper and for-sale items.

As shown in interface 300, a set of store 310 specific user-selectable options can be presented in the interface. These options include selectable controls 340 for locating an item, searching for an item in the store inventory, receiving item recommendations, viewing a shopper purchase history, viewing/activating coupons for items, determining a location history, accessing a series of previously viewed items, viewing or posting comments concerning an item, accessing information concerning recently purchased items, handling rebate forms, and the like. The set of controls 340 can be specifically configured for a store 310 and/or can be specifically configured by a user's preferences. Selecting any of the controls 340 can result in a related interface being presented (i.e., can include interfaces shown in scenarios 110-140 for example).

The GUI 300 can also include a tab for pre-purchase 320 information. Items such as a shopper's shopping list, preferred brands, running total for selected items, operational item accessories and enhancements (e.g., extended warranty and complementary items), and the like can appear when tab 320 is selected.

GUI 300 can also permit a user to specify their preferences 330. These preferences 330 can include item specific preferences, such as brand, cost, color, and the like. The preferences can also include preferences for what interactive prompts the user is to receive, a preferred interface 300 configuration for the shopper, and the like.

It should be appreciated that the interface 300 is presented for illustrative purposes only and that the invention is not to be construed as limited in this regard. Alternative interface control mechanism, interface modalities, and arrangements are contemplated. For example, the interface 300 can be implemented as a voice-only interface of a voice response system, instead of as a GUI interface. Specific implementation details can depend upon device capabilities, a set of user configurable interface preferences, and interface designer choices.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for storefront shopping comprising:
associating at least one item location beacon with at least one for-sale item in a store, wherein a plurality of for-sale items associated with different item location beacons are located within the store;
associating at least one shopper location beacon with a movable object proximate to a shopper present in the store;
determining an identity of the shopper;
obtaining shopper specific information from a data store to determine at least one of the for-sale items likely to be of interest to the shopper;
detecting when the shopper is within a designated distance of the determined for-sale item based upon a location of the item location beacon associated with the determined for-sale item and based upon a location of the shopper location beacon; and
responsive to the detecting step, automatically presenting information to the shopper via an electronic device about the determined for-sale item.

2. The method of claim 1, wherein the presented information includes a purchaser-satisfaction rating based upon feedback provided by past purchasers that indicates whether the past purchasers were satisfied with the determined for-sale item.

3. The method of claim 1, wherein the presented information includes at least one of product reviews for the determined for-sale item and past purchaser comments for the determined for-sale item.

4. The method of claim 1, wherein the presented information includes a comparison between the determined for-sale item and at least one similar item.

5. The method of claim 1, further comprising:
conveying a shopping list associated with the shopper to the data store, wherein the determined for-sale items comprise a set of items specified by the shopping list.

6. The method of claim 1, wherein the shopper location beacon and the item location beacons are Radio Frequency Identification (RFID) tags, and wherein a set of RFID sensors are used in the detecting step.

7. The method of claim 1, wherein the shopper location beacon is part of the electronic device, said electronic device including a wireless transceiver configured to wirelessly receive digital information from other devices, wherein a signal broadcast by the wireless transceiver is used to determine a location of the shopper, whereby the shopper location beacon comprises the wireless transceiver.

8. The method of claim 1, wherein the shopper location beacon is attached to the electronic device, and wherein the electronic device is at least one of a location-aware shopping cart, a location-aware shopping basket, and a mobile telephone.

9. The method of claim 1, wherein each of the item location beacons is integrated to a section-cataloging electronic device having a wireless transceiver, wherein each section-cataloging electronic device is associated with a plurality of proximate for-sale items.

10. The method of claim 1, wherein the movable object is uniquely associated with the shopper, wherein the identity of the shopper is automatically determined based upon a unique identifier of the movable object.

11. An enhanced shopping method comprising:
a computing system automatically determining a proximity between a storefront shopper and a for-sale item;
accessing a shopper data store containing shopper specific information;
initiating a shopper targeted event relating to both the shopper and the for-sale item, said event being based at least in part upon decisions based upon the accessed shopper specific information;
executing a programmatic action responsive to the initiated event; and
presenting upon a shopper accessible interface enhanced shopping information relating to a unique relationship between the shopper and the for-sale item.

12. The method of claim 11, wherein the shopper specific information includes a shopper's shopping list, said method further comprising:
detecting a shopper selection of the for-sale item, wherein the presented shopping information presents updated information pertaining to the shopper's shopping list.

13. The method of claim 12, wherein the for-sale item is an item associated with an item in the shopping list, wherein when the for-sale item is determined by the programmatic action to be identical to a corresponding shopping list item, the presented shopping information indicates that the shopping list item is satisfied by the for-sale item, and wherein when the for-sale item is determined by the programmatic action to be different from the corresponding shopping list item, the shopping information includes a notice about this difference.

14. The method of claim 11, wherein the shopper specific information includes a set of shopper preferences, said method further comprising:
a software program determining a likelihood that the shopper will be interested in the for-sale item based upon the shopper preferences, wherein the presented shopping information notifies the shopper of the for-sale item's proximity to the shopper and presents information specific to the for-sale item to the shopper via the shopper accessible interface.

15. The method of claim 14, wherein both the shopper and the for-sale item are associated with location beacons, wherein the proximity of the determining step is based upon an automatically detected proximity of the location beacons to each other.

16. The method of claim 15, wherein the location beacons wirelessly convey information to remote computing devices, where the wireless conveyance of information is used to determine the proximity of the location beacons to each other.

17. The method of claim 14, wherein the presented information specific to the for-sale item comprises at least one of:
a purchaser-satisfaction rating based upon feedback provided by past purchasers that indicates whether the past purchasers were satisfied with the for-sale item;
a set of product reviews for the for-sale item;
past purchaser comments for the for-sale item; and
a comparison between the for-sale item and at least one similar item.

18. An enhanced shopping system comprising:
a storefront within which shoppers purchase for-sale items;
a shopper data store configured to maintain shopper preferences relevant to the storefront;
an item data store configured to maintain information specific to the for-sale items; and
a shopper interface device configured to interactively present information to a shopper specific to the shopper and for-sale items proximately located to the shopper, wherein said presented information is customized based upon a relationship between the shopper and the for-sale items as determined from the shopper preferences and the information specific to the for-sale items.

19. The enhanced shopping system of claim 18, wherein the shopper interface device is a mobile device including a wireless transceiver which dynamically receives information from which the presented information is derived, wherein a shopper position and a position of the for-sale items is automatically determined based upon a location of a set of related location beacons which dynamically track positions of the shopper and the for-sale items, wherein each of the location beacons wirelessly convey information to remote computing devices, where the wireless conveyance of information is used to dynamically determine the proximity of the location beacons to each other, where programmatic events are automatically fired when the shopper is positioned within a previously designated range of particular ones of the location beacons associated with the for-sale items, wherein the programmatic events initiate programmatic actions, wherein the programmatic actions cause different information to be presented upon the shopper interface device.

20. The system of claim 18, wherein the interactively presented information comprises at least one of:
a purchaser-satisfaction rating based upon feedback provided by past purchasers that indicates whether the past purchasers were satisfied with the for-sale item;
a set of product reviews for the for-sale item;
past purchaser comments for the for-sale item;
a comparison between the for-sale item and at least one similar item; and
a shopping list associated with the shopper and a relationship between the for-sale item and an item included in the shopping list.
